(19) United States
(12) Patent Application Publication
(10) Pub. No.: US 2024/0351548 A1
(43) Pub. Date: Oct. 24, 2024

(54) METHODS OF FOLDING AN OCCUPANT AIRBAG FOR INCORPORATION INTO AN AIRBAG MODULE

(71) Applicant: Toyoda Gosei Co., Ltd., Kiyosu-Shi (JP)

(72) Inventors: Daniel Bujaidar, Washington Twp., MI (US); Srinivas Krishnan, Troy, MI (US); Roland Dominic Furtado, Novi, MI (US); Joshua Anthony Avery, Livonia, MI (US); David Stanley Dylong, Shelby Twp, MI (US)

(21) Appl. No.: 18/304,571

(22) Filed: Apr. 21, 2023

(51) Int. Cl. B60R 21/237

(52) U.S. Cl. CPC B60R 21/237; B60R 2021/2375

(57) ABSTRACT

Various methods are disclosed for folding a driver occupant airbag for incorporation into an associated airbag module. One method includes steps of positioning the airbag on a working surface, pinching at least one portion of an edge of the airbag along a rapid deployment axis of the airbag, laterally compressing the airbag, and longitudinally compressing the laterally compressed airbag to provide an installation-ready airbag component suitable for installation into an airbag module. Pinching the airbag at one or more locations along the rapid deployment axis during folding may cause the pinched airbag portions to deploy more rapidly than other portions of the airbag when the airbag is inflated. Alternative folding methods are also disclosed.

### TECHNICAL FIELD

The present invention relates to airbags for vehicle occupant protection systems and, more particularly, to an occupant airbag structured for installation in an occupant compartment of a vehicle.

### BACKGROUND

It is known to install occupant airbags in passenger vehicles. The occupant airbags may be configured to automatically deploy to protect a vehicle occupant if the vehicle is involved in a collision or if processed data from one or more sensors in the vehicle determine that a collision is pending. In specific applications of the occupant airbag, it may be desirable to vary the times required for various portions of the airbag to deploy and/or to vary the order in which the various portions of the airbag deploy during inflation.

### SUMMARY

In one aspect of the embodiments described herein, a method is provided for folding an airbag to provide an installation-ready airbag component for an airbag module. The method includes steps of positioning the airbag on a working surface, pinching at least one portion of an edge of the airbag along a rapid deployment axis of the airbag, laterally compressing the airbag, and longitudinally compressing the laterally compressed airbag.

In another aspect of the embodiments described herein, an occupant airbag for a vehicle is provided. The occupant airbag includes at least one pinched edge portion residing along a rapid deployment axis of the airbag.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale. Also, unless otherwise stated or shown, the same or similar elements shown in different views may be given the same or similar reference numerals or designations.

FIG. 1 is a schematic plan perspective view of an occupant airbag positioned in an airbag folding structure prior to folding of the airbag in accordance with a first folding method described herein.

FIG. 1A is a schematic plan view of the airbag shown in FIG. 1, laid out flat on a working surface without the airbag folding structure shown.

FIG. 2 is the schematic plan perspective view of FIG. 1 showing a pinching operation being performed on portions of opposed edges of the airbag using the airbag folding structure to form laterally-extending lobes.

FIG. 2A is a schematic plan view of the arrangement shown in FIG. 2 with portions of the airbag folding structure removed to more clearly illustrate the formation of a laterally-extending lobe along each side of a pinch axis PX1 of the airbag as a result of the pinching operation.

FIG. 3 is a schematic plan perspective view of the arrangement shown in FIGS. 1 and 2, illustrating performance of a lateral compression operation on the laterally-extending lobes of the airbag following the step shown in FIG. 2.

FIG. 3A is a schematic plan view of the arrangement shown in FIG. 3 without the airbag folding structure to more clearly illustrate the effect of laterally compressing the laterally-extending lobes.

FIG. 4 is a magnified view of a portion of FIG. 3, showing an advanced stage of lateral compression of the laterally-extending lobes.

FIG. 5 is a schematic plan perspective view showing a longitudinal compression of the airbag following completion of the lateral compression operation shown in FIGS. 3-4.

FIG. 6 is a schematic plan view of an embodiment of the airbag after completion of the folding operations shown in FIGS. 1-5, and showing the folded airbag mounted in a housing of an airbag module.

FIG. 7A is a schematic plan view of an airbag folded in accordance with the folding method illustrated in FIGS. 1-5, shown just after activation of an airbag inflator operably connected to the airbag.

FIG. 7B is the schematic plan view of FIG. 7A, showing a deployment trajectory of the inflating airbag along a 12 o'clock-6 o'clock rapid deployment axis of the airbag.

FIG. 8A is a schematic plan view of an occupant airbag positioned flat on a working surface and illustrating a wrap-over step and a pinching step in accordance with another folding method described herein.

FIG. 8B is a schematic side view of the airbag shown in FIG. 8A during the pinching and wrap-over operations.

FIG. 9A is a schematic plan view of an occupant airbag positioned on a working surface and illustrating a step of (prior to performing any folding operations) positioning a portion of an airbag on a projection extending from a working surface on which a remainder of the airbag rests, in accordance with yet another folding method described herein.

FIG. 9B is a schematic cross-sectional view of the airbag shown in FIG. 9A.

FIG. 9C is a schematic cross-sectional view of an airbag module containing an airbag in a completely folded condition following positioning of the airbag on a projection extending from a working surface as shown in FIGS. 9A and 9B, illustrating a deployment effect of positioning of the airbag on the projection prior to folding.

FIG. 10A is a schematic side perspective view of a vehicle seat incorporating a side airbag folded in accordance with an embodiment described herein, with the airbag in a stowed position in the seat prior to activation.

FIG. 10B is the schematic side perspective view of FIG. 10 showing the side airbag in a deployed condition.

FIG. 11 is a schematic plan view of the airbag shown in FIG. 10B, laid out flat on a working surface for folding, without any airbag folding structure shown.

FIG. 12 is a schematic plan view of an arrangement similar to the view of FIG. 2A, with portions of the airbag folding structure removed to more clearly illustrate the formation of a laterally-extending lobe along each side of a pinch axis PX2 of the airbag as a result of the pinching operation.

FIG. 13 is a schematic plan view similar to the view of FIG. 3, illustrating performance of a lateral compression operation on the laterally-extending lobes of the airbag of FIGS. 10B-12 by a pair of opposed lateral compression members following the step shown in FIG. 12.

FIG. 14 is a schematic plan view similar to the view of FIG. 5, showing a longitudinal compression of the airbag of FIGS. 10B-13 following completion of the lateral compression operation shown in FIG. 13.

### DETAILED DESCRIPTION

Embodiments described herein relate to various methods for folding an occupant airbag for incorporation into an associated airbag module. In one aspect, the method includes steps of positioning the airbag on a working surface, pinching at least one portion of an edge of the airbag along a rapid deployment axis of the airbag, laterally compressing the airbag, and longitudinally compressing the laterally compressed airbag to provide an installation-ready airbag component suitable for installation into an airbag module. Pinching the airbag at one or more locations along the rapid deployment axis during folding may cause the pinched airbag portions to deploy more rapidly than other portions of the airbag when the airbag is inflated. In another aspect, a portion of an edge of the airbag may be wrapped over another portion of the airbag during folding. This may cause the wrapped-over edge portion of the airbag to deploy more slowly than remaining portions of the airbag when the airbag is inflated. In yet another aspect, a portion of the airbag may be elevated during folding so that the elevated portion resides above the remainder of the airbag during folding. The elevated portion of the airbag may be form a volume of interior space into which inflation gas is first introduced into the airbag after activation of a connected airbag inflator. The inflation gases may proceed from this volume of space into the remaining, folded portion of the airbag. For an airbag folded in any particular manner, this elevation of the portion of the airbag may aid in producing a more consistent inflation trajectory than the airbag would have if no portion of the airbag is elevated.

As used herein, the term “occupant” refers to any person or other living entity seated in any seat provided inside the vehicle occupant compartment. Similarly, the term “occupant airbag” refers generally to any airbag structured and mountable to the vehicle so as to be operable to cushion a vehicle occupant when activated (for example, prior to or during a collision scenario). Thus, “occupant airbag” may non-exclusively refer to a driver airbag, a knee airbag, a curtain airbag, a side airbag, and any other type of airbag. Examples of specific types of occupant airbags will be described herein to illustrate the principles and applications of the present invention.

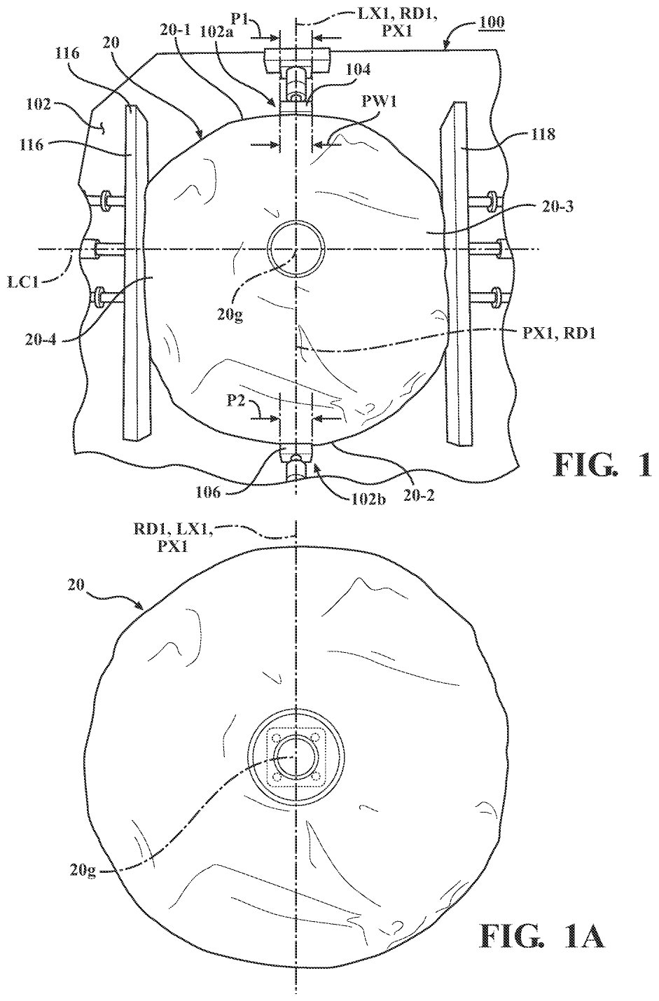

FIGS. 1-5 illustrate a method of folding an occupant airbag 20 in accordance with a first embodiment described herein. In particular arrangements, the airbag 20 may be a driver airbag structured for installation in a steering wheel of a vehicle.

It has been found that aspects of the airbag deployment trajectory, including the consistency of the deployment, may be affected by the degree, type, and locations of various folding operations applied to the airbag as described herein, prior to loading the airbag into an airbag module.

Any of the airbag folding steps described herein may be performed manually, automatically (i.e., without manual assistance, using a suitably configured automated folding/assembly machine), or semi-automatically (using a combination of manual and automated steps). Manual folding of the airbag 20 or a portion of the airbag may be done completely by hand, or manual folding may involve the manual manipulation of various tools or implements which facilitate folding the airbag as described.

In one example, assisted or semi-automated folding of the airbag 20 may be performed using a suitable airbag folding structure. FIGS. 1-5 show schematic plan views of an occupant airbag 20 positioned in an airbag folding structure 100 during various stages of folding. The airbag folding structure 100 may include including various implements coupled to each other and/or arrangeable with respect to each other to facilitate folding of the airbag 20.

In one or more particular arrangements, the airbag folding structure 100 may include a working surface 102 (such as an airbag folding table) along which the airbag 20 may be laid for folding. In some arrangements, the working surface 102 may be flat.

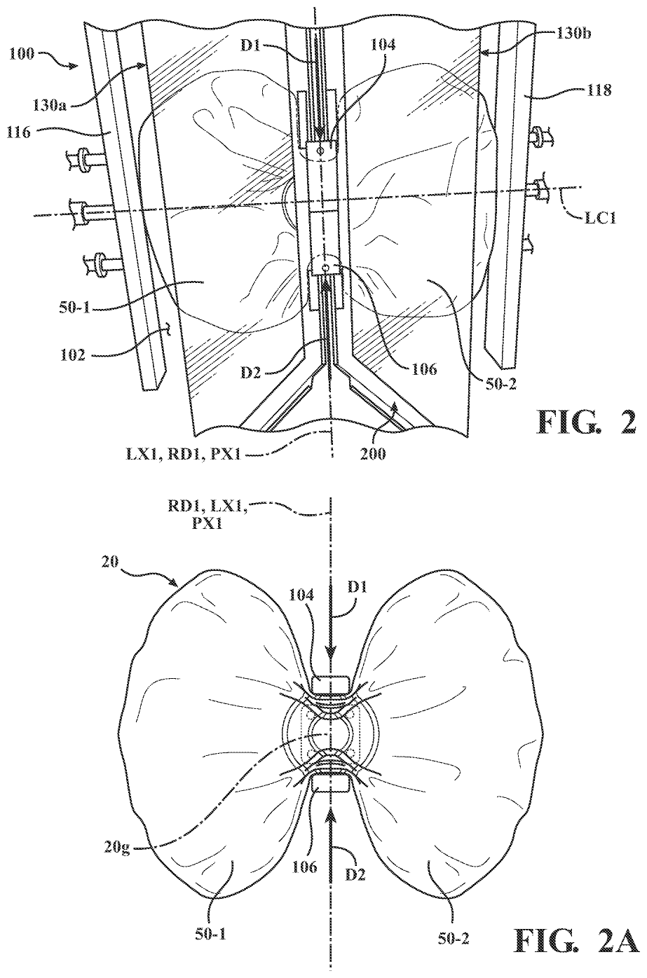

Referring to FIGS. 1-2A, the airbag folding structure 100 may include one or more pinching members 104, 106 structured to be movable toward associated edge(s) of the airbag to pinch the edge(s) of the airbag lying on the working surface 102. “Pinching” may be defined as a localized compression of a portion of a circumferential or outermost edge of the airbag when the airbag is lying on the working surface 102. The portion of the edge to be pinched may be defined in terms of an arc length (along a curved edge of the airbag) or in terms of a linear dimension (along a straight edge). The line of action (or “pinch axis”) PX1 of a pinching operation may lie generally perpendicular to an edge of the airbag being pinched. Referring to FIG. 1, a dimension P1 of a given pinching member 104 extending perpendicular to the line of action PX1 may be specified so as to correlate with the arc length or linear dimension PW1 of the portion 20-1 of the airbag edge to be pinched. In certain embodiments described herein, a pinch axis PX1 may coincide with a rapid deployment axis RD1 of the airbag (described in greater detail below).

Referring to FIGS. 1-5, the airbag folding structure 100 may include one or more longitudinal compression members structured to be movable along a longitudinal compression axis LX1 to compress one or more associated sides of an airbag laying on the working surface 102. The embodiment shown in the drawings includes two longitudinal compression members 112, 114. In one or more arrangements described herein, the longitudinal compression members 112, 114 may be attachable to (and operable by) the same mechanism that controls movement of the pinching members 104, 106.

The airbag folding structure 100 may also include one or more lateral compression members structured to be movable to compress an airbag 20 laying on the working surface 102 along a lateral compression axis LC1 extending orthogonal to the longitudinal compression axis LX1. The embodiment shown in the drawings includes two lateral compression members 116, 118.

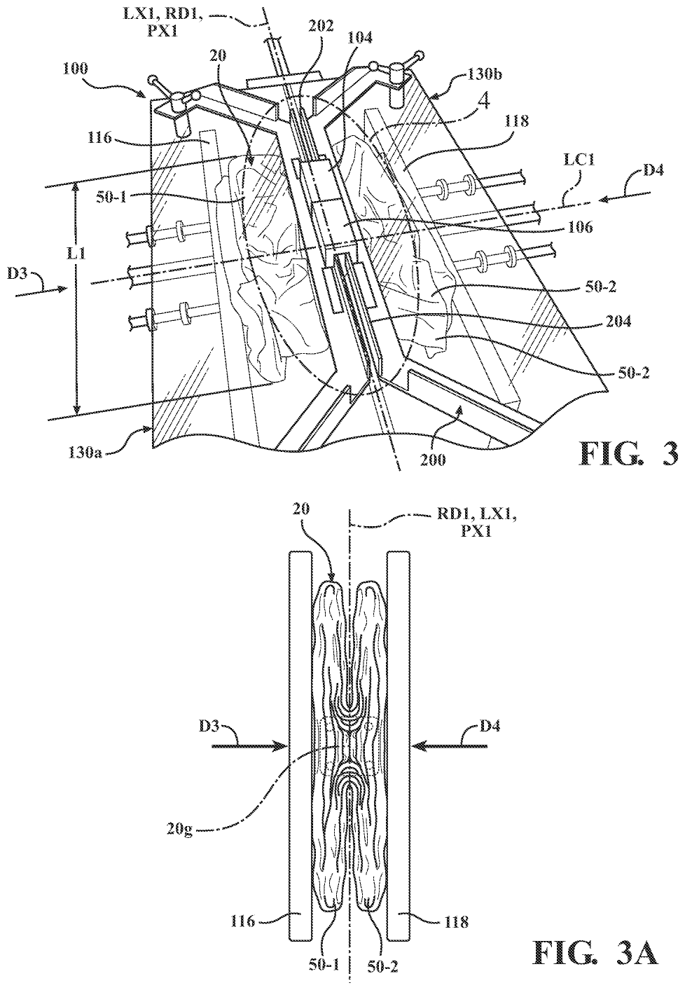

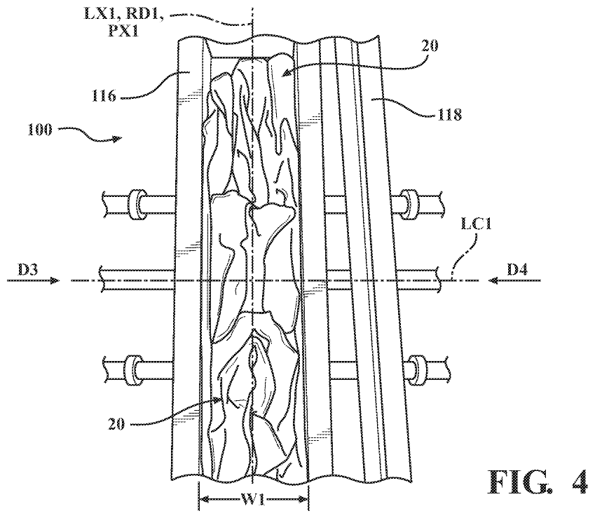

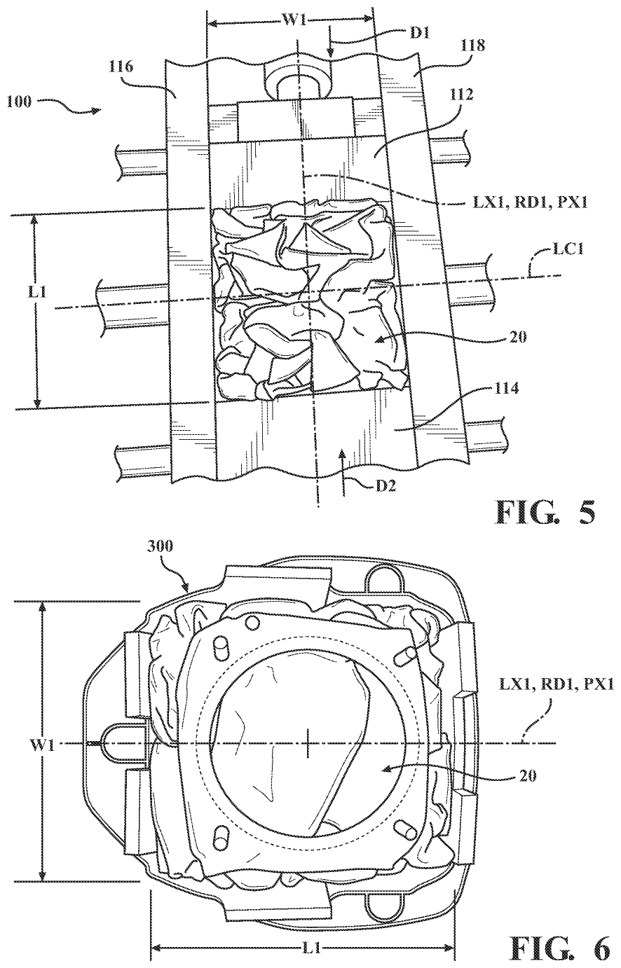

“Compression” of the airbag 20 may be defined as pressing the airbag along one or more edges thereof in direction(s) generally orthogonal with respect to the compressed edge(s), using a compression member that extends along a dimension encompassing an entire side of the airbag. Referring to FIGS. 3-4, for example, “laterally compressing” the airbag 20 may comprise compressing the airbag along an entire length dimension L1 of the airbag at the time of the lateral compression step, in opposite directions D3 and D4 orthogonal with respect to the longitudinal compression axis LX1, by moving lateral compression members 116, 118 in directions D3 and D4 along the lateral compression axis LC1. Similarly, referring to FIG. 5, “longitudinally compressing” the airbag 20 may comprise compressing the airbag along an entire width dimension W1 of the airbag at the time of the longitudinal compression step by moving longitudinal compression members 112 and 114 in respective direction(s) D1 and D2 along the compression axis LX1. Thus, in embodiments described herein, the airbag 20 may be laterally compressed along opposite lateral edges of the airbag and longitudinally compressed along opposite longitudinal edges of the airbag. In one or more particular arrangements, the longitudinal compression axis LX1 may coincide with the airbag rapid deployment axis RD1.

In the example folding structure 100 shown in FIGS. 1-5, a support frame (generally designated 200) may be suspended above the working surface 102 prior to folding the airbag. The support frame 200 may define a pair of opposed rails 202, 204 structured to support and guide pinching members 104, 106 and/or longitudinal compression members 112, 114 along common respective axes of operation PX1, LX1 during pinching and compression of the airbag 20.

The pinching members 104, 106, the longitudinal compression members 112, 114 and the lateral compression members 116, 118 may be structured to move smoothly along the working surface 102 during airbag folding. In some arrangements, the various pinching and/or compression members may be hydraulically or pneumatically actuatable. Alternatively, the various pinching and/or compression members may be manually actuatable (using one or more levers structured to control movement of the compression members, for example).

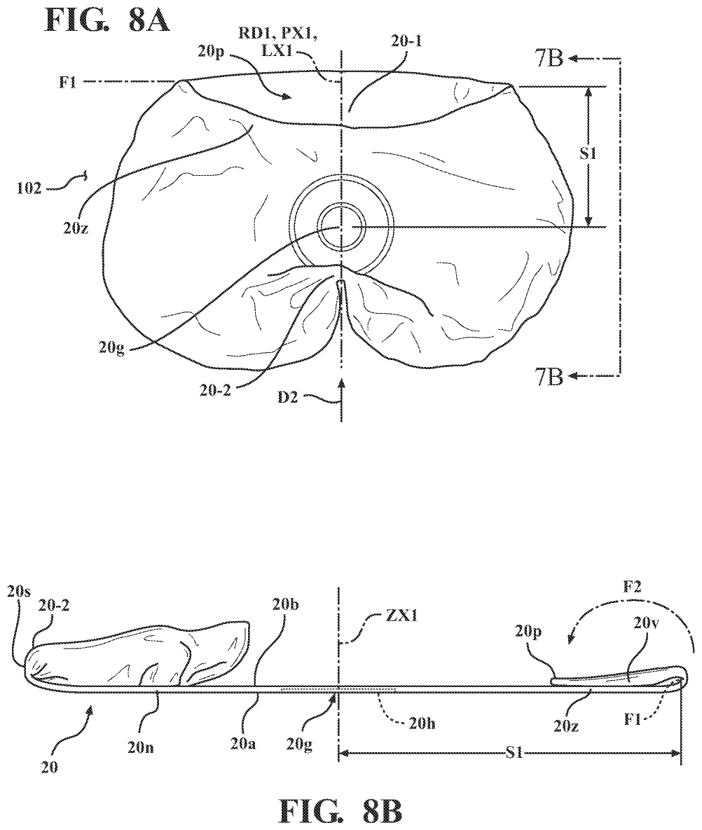

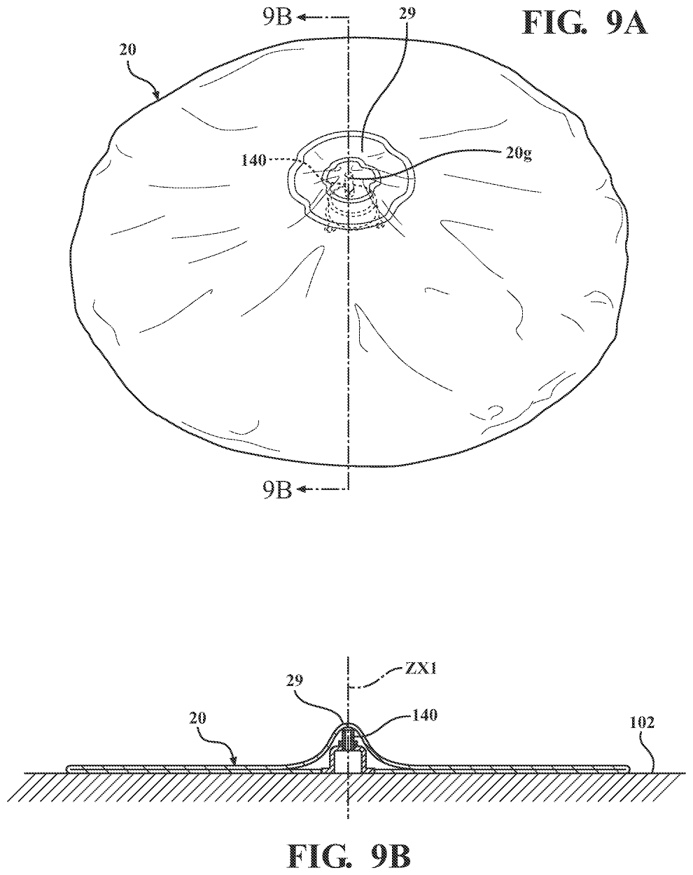

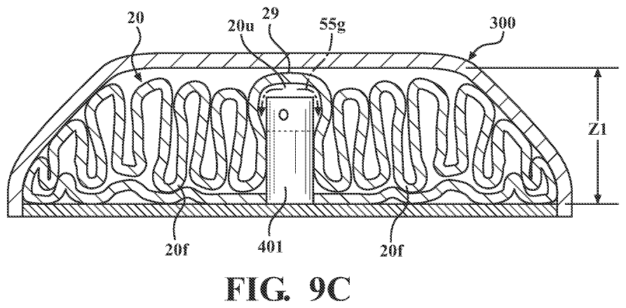

The airbag folding structure 100 may also include one or more Z-axis compression members positioned so as to overlie the working surface 102. The airbag folding structure 100 of FIGS. 1-5 includes a pair of adjacent Z-axis compression members 130a and 130b. These Z-axis compression members 130a, 130b may be structured and positioned so as to extend parallel to the working surface 102 during airbag folding. The Z-axis compression members 130a, 130b may be structured to confine the airbag 20 in directions along a Z-axis ZX1 (FIG. 8B) extending perpendicular to the working surface 102 during folding. The Z-axis compression members 130a, 130b may restrict the airbag to a Z-axis dimension Z1 (FIG. 9C) when folded. The dimension Z1 may be selected so that airbag 20 in its final folded form fits into an associated airbag module housing 300.

The Z-axis compression members 130a, 130b may be formed from a transparent material to enable an operator to monitor the condition of the airbag 20 during folding. In one or more arrangements, the Z-axis compression members 130a, 130b may be formed from a sheet of a suitable material, such as a polymer or glass.

Generally, in an example where the occupant is the driver and the occupant airbag 20 is a driver airbag, the airbag is designed to deploy to protect the head and torso of the driver. To help ensure that the airbag 20 exhibits certain inflation characteristics, it may be desirable to orient the airbag in a specific way with respect to the airbag folding structure 100 prior to folding. Specifically, it may be desirable to orient the airbag so as to deploy parts of the occupant airbag 20 protecting the occupant's head and torso as rapidly as possible upon inflator activation. Since the head and torso lie along a straight axis of the occupant's body, a “rapid deployment axis” RD1 of the occupant airbag 20 may be defined as including portions of the airbag designed to directly contact and cushion the occupant's head and torso. A “rapid deployment axis” of the airbag may be an axis along which it is desired to have one or more portions of the airbag deploy as rapidly as possible upon inflator activation, and before other portions of the airbag deploy. Thus, the rapid deployment axis RD1 may be an axis along which a head and torso of a vehicle occupant will extend with respect to the airbag when the airbag 20 is installed in a steering wheel of the vehicle. In addition, the longitudinal compression members 112, and 114 may be structured to operate along the rapid deployment axis RD1 as shown in FIG. 5.

In addition, the types of folds, locations of the folds, and the sequence of the folds may determine the deployment characteristics of the airbag. To reference and differentiate between various portions of the airbag for purposes of folding, a “clock-based” reference system may be utilized. One example of such a system is illustrated in the drawings. In some arrangements, the clock positions may be located with respect to the axes LX1/RD1/PX1 and LC1 along which the lateral and longitudinal compression members will move during airbag folding. Thus, referring in particular to FIG. 1, what will be a portion 20-1 of the airbag 20 facing upwardly (from the perspective of an occupant facing the steering wheel) when the airbag is installed in the steering wheel may be positioned at a “12 o'clock position” 102a of the working surface 102 prior to folding. This portion 20-1 of the airbag 20 will be contacted by an occupant's head when the airbag is inflated. Consequently, a portion 20-2 of the airbag 20 residing lower along the rapid deployment axis RD1 and designed to protect the occupant's torso may be positioned at a “6 o'clock position” 102b of the working surface 102 prior to folding. Thus, in the arrangement shown, the portion 20-1 of the airbag 20 designed to cushion the occupant's head may define a 12 o'clock portion of the airbag. Similarly, the portion 20-2 of the airbag 20 designed to cushion the occupant's torso may define a 6 o'clock portion of the airbag. Also, in the arrangement shown, the lateral compression members 116 and 118 may operate along a compression axis LC1 extending between a corresponding 3 o'clock portion 20-3 of the airbag 20 and a 9 o'clock portion 20-4 of the airbag.

In the manner described herein, the clock reference positions may enable portions of an occupant's body to be associated with portions of the airbag 20 where folds and pinches are to be located to impart particular inflation characteristics to the airbag. This enables folds and pinches to be applied to selected portions of the airbag so as to achieve desired airbag deployment effects upon activation of the inflator.

In embodiments described herein, and as seen in FIGS. 1, 1A and 9A, the airbag 20 may be structured to have a circular shape in plan view when positioned in a flat, uninflated state on a flat working surface 102 prior to folding. Referring to FIG. 8B, in an uninflated state, the airbag 20 may have a first face 20a and a second face 20b positioned opposite the first face 20a. The airbag faces 20a and 20b may be attached to each other along one or more seams 20s extending along peripheral edges of the faces. The first and second faces 20a and 20b may be formed by two separate circular panels stitched together along their edges, for example. The space between the first and second faces 20a and 20b may define an interior 20n of the airbag.

In addition, as shown in FIG. 8B, an airbag having a circular shape and the configuration described herein may be structured to receive inflation gas into the airbag interior 20n through an opening 20h formed in the first face 20a at a geometric center 20g of the first face. For example, when the folded airbag 20 is mounted in an airbag module, the airbag opening 20h may be connected to a suitable airbag inflator so that the airbag interior 20n is in fluid communication with a gas diffuser 401 of the inflator (as seen in FIG. 9C).

Each of the folding methods described herein may progress through one or more intermediate steps to provide one or more associated intermediate airbag components, to a final folding step which provides an associated installation-ready airbag component for an airbag module. An “installation-ready airbag component” may be an airbag in its final folded form, after completion of all intermediate steps and ready for insertion or installation into the airbag module housing. “Folding” as used herein may refer to any operation performed on the airbag to transform the airbag from a flat, uninflated, unconstrained state resting on a working surface to a compact state suitable for installation into a housing of an airbag module. Such operations may include compressing, pinching, and wrapping over as described herein, as well as any other operations necessary to transform the airbag into an installation-ready airbag component.

Referring again to FIGS. 1-5, in a first step, air that may have entered the airbag interior 20n during fabrication or handling may be removed from the airbag interior. This may minimize separation between opposite faces 20a, 20b of the airbag 20 prior to folding and aid in laying the airbag out on the working surface 102. Removal of the air may also reduce resistance to folding operations due to counter-pressure exerted by interior air pockets. In one or more arrangements, the air may be removed by application of a vacuum to the interior of the airbag. In other arrangements, the air may be removed by simply compressing the airbag as it lays flat on the working surface.

Referring to FIGS. 1 and 1A, in a next step, the airbag 20 may be positioned so as to lie flat on the working surface 102. In some arrangements, the airbag 20 may be positioned on the working surface 102 prior to removal of air from the interior.

Referring to FIGS. 2-2A, in a next step, an edge of the airbag 20 may be pinched along at least one portion of the edge. It has been found that, for an airbag having a circular shape and the structure described herein, and with the airbag being configured to receive inflation gas into the airbag interior through an opening formed at a geometric center of the airbag, portions of the airbag which are pinched as described herein during folding operations will expand and deploy more rapidly during airbag inflation than unpinched portions of the airbag. This effect of pinching may be used to ensure more rapid deployment of the airbag portions 20-1 and 20-2 cushioning the occupant's head and torso, respectively. Thus, to facilitate more rapid deployment of the airbag portion protecting the occupant's torso, the 6 o'clock portion 20-2 of the airbag may be pinched along the rapid deployment axis RD1.

Also, in one or more arrangements, other portion(s) of the airbag may also be pinched to provide a rapid deployment effect. For example, to facilitate more rapid deployment of the airbag portion 20-1 protecting the head, the 12 o'clock portion 20-1 of the airbag 20 may be pinched along the rapid deployment axis RD1. The two portions 20-1 and 20-2 of the airbag 20 may be pinched simultaneously or sequentially. Referring to FIGS. 2-2A, as a result of pinching the portions 20-1 and 20-2 of the airbag, a pair of opposed laterally-extending lobes 50-1 and 50-2 (i.e., lobes extending to each side of the rapid deployment axis RD1) may be formed.

In one or more arrangements, to provide the beneficial effects of pinching in any of various different types of occupant airbags (i.e., driver airbags, side airbags, curtain airbags, knee airbags, etc.), the pinching of the portion of the edge of the airbag may be in a direction toward a location where inflation gas is to enter the airbag. For example, in the airbag 20 described with regard to FIGS. 1-7, with the airbag being configured to receive inflation gas into the airbag interior through an opening formed at a geometric center of the airbag, the airbag may be pinched in direction(s) toward the geometric center of the airbag. As another example, in some arrangements, the airbag may be pinched in direction(s) toward a centroid of an area of the opening in the airbag into which inflation gas is to be directed (e.g., in airbags having a single gas inlet opening).

In addition, in one or more arrangements, the airbag may be pinched in a given direction until the portion of the air bag being pinched reaches the location where inflation gas is to enter the airbag or until the portion of the air bag being pinched physically contacts a feature or object that prevents further pinching of the portion of the airbag in the direction in which the portion of the airbag is being pinched.

Referring to FIG. 4, in a next step, the airbag 20 may be laterally compressed in directions D3 and D4 using the lateral compression members 116 and 118, respectively, as shown in FIGS. 3-4. This operation may compress the lobes 50-1 and 50-2 toward the rapid deployment axis RD1.

Referring to FIG. 5, in a final folding step, the laterally compressed airbag 20 may be longitudinally compressed in directions D1 and D2 using longitudinal compression members 112 and 114, respectively, to provide the installation-ready airbag component. Because the pinching dimensions P1 and P2 may not be the same as the width W1 of the airbag after the lateral compression step, the pinching members 104, 106 may be replaced by the longitudinal compression members 112 and 114 prior to the longitudinal compression operation, if needed. The longitudinal compression members 112 and 114 may be sized to longitudinally compress the airbag along the entire current width dimension W1. The lateral and longitudinal compression steps described above may reduce the overall length dimension L1 and width dimension W1 of the airbag 20 so that the airbag in its final folded form fits inside the space envelope of the airbag module housing 300 during installation, as shown in FIG. 6.

Installation of the folded airbag 20 into the module housing may include any steps required to make the airbag readily deployable from the housing, including operably connecting an interior of the airbag to a gas source (such as an airbag inflator) (not shown) so that the airbag will deploy upon activation of the inflator.

The folded airbag 20 may then be installed in the module housing 300. The folded airbag can be directly pushed into the cavity of the module housing, or it can be packed using a fabric wrap. After airbag installation, a module cover (not shown) may be applied to the housing 300 to seal the module.

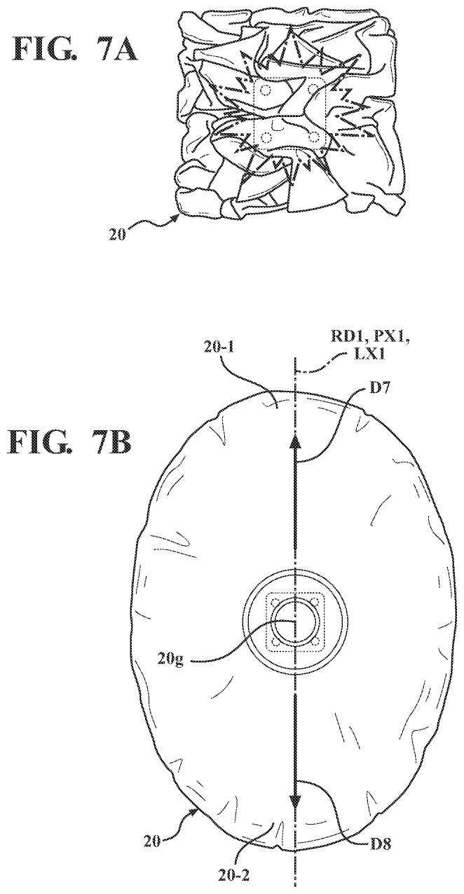

FIGS. 7A-7B illustrate the initial phase of deployment of an airbag 20 that has been pinched at the 12 o'clock and 6 o'clock positions during folding, as described above. In FIG. 7A, an airbag inflator (not shown) operably connected to the airbag 20 has just been activated. The inflator generates inflation gas which enters the airbag interior 20n, causing the previously pinched airbag portions 20-1 and 20-2 of the airbag (along the rapid deployment axis RD1) to deploy more quickly that other portions of the airbag. Rapid deployment of these portions of the airbag may help cushion the occupant's head and torso as soon as possible after a collision event (or prior to a pending collision event).

FIGS. 8A and 8B illustrate steps included in an alternative method of folding the airbag 20. The alternative folding method may be variation of the method previously described with regard to FIGS. 1-5.

In a first step of the alternative folding method, as in the previously described folding method, air that may have entered the airbag 20 interior during fabrication or handling may be removed from the airbag interior.

In a next step, as in the previously described folding method, the airbag 20 may be positioned so as to lie flat on the working surface 102. In some arrangements, the airbag 20 may be positioned on the working surface prior to removal of air from the interior. Also, as previously described, the airbag 20 may be structured to have a circular shape in plan view when positioned in a flat state on the working surface 102 prior to folding.

Referring to FIG. 8A, in a next step, one portion of an edge of the airbag 20 may be pinched in direction D2 along a desired rapid deployment axis RD1 of the airbag as previously described. In the embodiment shown, the airbag 20 is pinched at a 6 o'clock portion 20-2 of the airbag.

In addition to pinching at a single location, the alternative method may also include a step of, prior to the step of laterally compressing the airbag 20, wrapping over a portion 20p of the airbag 20 in direction F2 (FIG. 8B) so as to overlie another portion 20z of the airbag as shown in FIGS. 7A and 7B, so that the wrapped edge portion 20p and the other airbag portion 20z are vertically “stacked” on the working surface 102. In the arrangement shown, for example, a 12 o'clock portion 20-1 of the airbag edge is wrapped over so as to overlie another, remaining portion 20z of the airbag adjacent the 12 o'clock portion. In one or more arrangements, the wrapped portion 20p of the airbag edge may be wrapped over along a fold line F1 extending perpendicular to the rapid-deployment axis RD1. Thus, in the arrangement shown in FIGS. 7A and 7B, the portion of the airbag 20 to be pinched resides at a 6 o'clock portion 20-2 of the airbag prior to folding, and the portion 20p of the airbag to be wrapped over is located at a 12 o'clock portion 20-1 of the airbag prior to folding.

The wrapping step may be performed before, after, or simultaneously with the pinching step, as long as both the pinching step and the wrapping step are performed prior to any compression steps as described herein. It has been found that wrapping over an edge of the airbag as described herein may cause a delay in full deployment of the wrapped portion of the airbag, so that the wrapped portion fully deploys only after full deployment of any pinched portions of the airbag and also after full deployment of any remaining portions of the airbag. Thus, the wrapping step may be applied to portion(s) of the airbag for which a delayed deployment is desired.

It has also been found that, for an airbag having a circular shape and the structure described herein, and where the airbag is configured to receive inflation gas into the airbag interior through an opening formed at a geometric center of the airbag, the time required for the wrapped portion 20p of the airbag to fully deploy may correlate inversely with a predetermined distance S1 from the airbag geometric center 20g to the fold line F1 (i.e., the shorter the distance S1 from the geometric center 20g to the fold line F1, the greater the amount of time will be needed for the wrapped portion 20p of the airbag edge to fully deploy). The distance S1 from the geometric center 20g to the fold line F1 also inversely correlates with an internal volume 20v of the wrapped portion 20p.

In particular arrangements, for an airbag structured to have a circular shape in plan view and having an outer diameter of about 700 millimeters when laid flat on a working surface 102 with residual air removed, the fold line F1 may be located about 230 millimeters from the geometric center 20g of the circular shape. An S1 value of 230 millimeters has been found to provide a suitable delay in full deployment of the 12 o'clock portion 20-1 of the airbag edge for an airbag having the stated diameter.

FIGS. 9A and 9B illustrate steps included in another alternative method of folding the airbag 20.

In a first step of the other alternative folding method, residual air that may have entered the airbag interior during fabrication or handling may be removed from the airbag interior. The airbag may be structured to have a circular shape in plan view when positioned in a flat state on a working surface prior to folding, as previously described.

In a next step, the airbag 20 may be positioned so as to lie on the working surface 102. However, in the other alternative method, a projection 140 may extend from the working surface 102 as shown in FIGS. 9A and 9B. The projection 140 may be structured to contact a portion 29 of the airbag 20 so as to elevate the portion 29 of the airbag above the remainder of the airbag as shown in FIGS. 9B and 9C, both before and after folding of the remainder of the airbag 20 is complete. In the circularly-configured airbag shown in FIGS. 9A-9C, the portion 29 of the airbag positioned on the projection 140 may be located at the geometric center 20g of the circular shape. In the airbag embodiment shown, the geometric center 20g of the airbag shape in plan view may also correspond to a location where inflation gas is introduced into the airbag interior to deploy the airbag.

It has been found that elevating a portion 29 of the airbag prior to folding operates to maintain this portion of the airbag in a relatively exposed and unconstrained position relative to the folded portions 20f of the airbag. It has also been found that elevating a portion of the airbag in this manner prior to folding helps ensure a more consistent deployment trajectory of the airbag. Referring to FIG. 9C, it is believed that elevating a portion 29 of the airbag as described may provide a volume of space 20u surrounding the inflator gas diffuser 401 into which inflation gas 55g may enter and uniformly expand prior to filling the folded remaining portions 20f of the airbag 20. It is believed that filling the folded portions 20f of the airbag from this volume of space 20u rather than injecting gas directly into the folded portions 20f of the airbag helps provide consistent, repeatable deployment trajectories in airbags fabricated as just described.

In one particular variation of the other alternative folding method, following positioning of a portion 29 of the airbag 20 on the projection 140 to provide the elevated portion of the airbag, the 12 o'clock and 6 o'clock portions of the airbag along the rapid deployment axis RD1 may be pinched as previously described with regard to the first folding method. Then, the airbag may be laterally compressed as previously described. Then, in a final folding step, the laterally compressed airbag may be longitudinally compressed to provide the installation-ready airbag component as previously described.

In embodiments in which the airbag is positioned on a projection prior to folding, the elements of the airbag folding structure 100 (such as the various pinching members and compression members) may be structured to accommodate the elevated central portion of the airbag during folding.

In another particular variation of the other alternative folding method, following positioning of a portion 29 of the airbag 20 on the projection 140 to provide the elevated portion of the airbag, the 12 o'clock portion 20-1 of the airbag 20 may be wrapped over another portion 20z of the airbag and the 6 o'clock portion 20-2 of the airbag 20 may be pinched as previously described with respect to the first alternative folding method. Then, the airbag 20 may be laterally compressed as previously described. Then, in a final folding step, the laterally compressed airbag may be longitudinally compressed to provide an installation-ready airbag component as previously described.

In another aspect of the embodiments described herein, an occupant airbag folded so as to provide installation-ready airbag component is provided. In one or more arrangements, the occupant airbag may include at least one pinched edge portion residing along a rapid deployment axis of the airbag. For example, FIG. 8A shows an embodiment of an occupant airbag pinched along an edge of airbag portion 20-2.

The airbag may be structured to have a circular shape in plan view when positioned in a flat, uninflated state on a flat working surface prior to folding, as shown in FIG. 1A. In addition, a pinch axis of the pinched edge portion of the airbag may extend through a geometric center of the circular shape. For example, FIG. 8A shows the airbag 20 with the pinched edge portion located along a pinch axis PX1 extending through a geometric center 20g of the airbag 20.

In one or more arrangements, the folded airbag may have another pinched edge portion residing diametrically opposite the first pinched edge portion. For example, FIGS. 2 and 2A show airbag 20 having a pair of diametrically opposite pinched edges of airbag portions 20-1 and 20-2.

In airbags having a pair of diametrically opposite pinched edge portions, a pair of compressed laterally-extending lobes may be formed with one lobe of the pair of lobes being formed along on each side of opposite sides of the rapid deployment axis (e.g., lobes 50-1 and 50-2 formed on opposite sides of rapid deployment axis RX1 as shown in FIGS. 2 and 2A.

In some arrangements, prior to performing compression operations on the airbag, a portion of an edge of the airbag may be wrapped-over so as to overlie another portion of the airbag, as shown in FIGS. 7A and 7B.

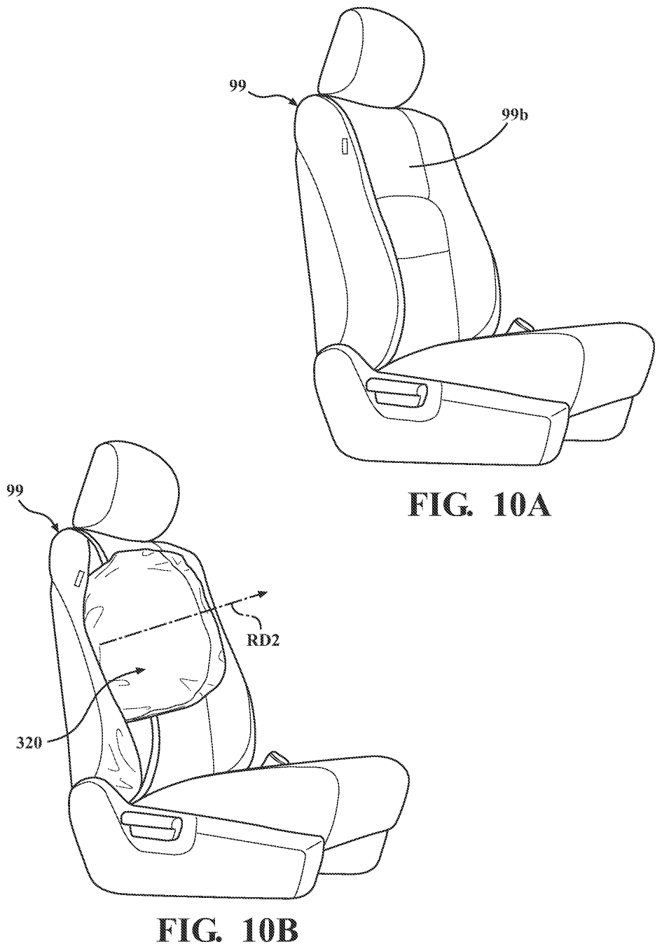

Referring now to FIGS. 10A-14, a side airbag 320 may be mounted in the side of a vehicle seat 99 for activation in the event of a side impact on the vehicle.

FIG. 10A is a schematic side perspective view of the vehicle seat 99 incorporating a side airbag folded in accordance with an embodiment described herein, with the airbag in a stowed position in the seat 99 prior to activation. FIG. 10B is the schematic side perspective view of FIG. 10 showing the side airbag 320 in a deployed condition. The airbag may be structured and folded so as to deploy along a rapid deployment axis RD2 when activated. In some arrangements, the rapid deployment axis RD2 may extend generally perpendicular to a seat back 99b against which a seat occupant (not shown) rests.

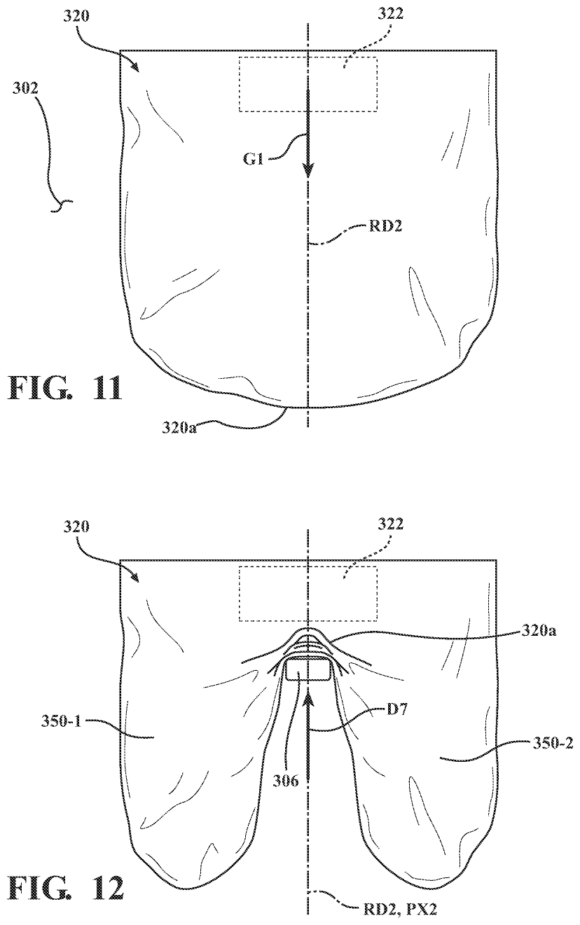

FIG. 11 is a schematic plan view of the airbag 320 shown in FIG. 10B, laid out flat on a working surface 302 for folding, without any airbag folding structure shown. Referring to FIG. 11, prior to folding, the airbag 320 may be positioned so as to lie flat on a working surface 302 as previously described with regard to the airbag embodiment 20 of FIGS. 1-7. In some arrangements, the airbag 320 may be positioned on the working surface 302 prior to removal of air from the interior.

FIG. 12 is a schematic plan view of an arrangement similar to that shown in FIG. 2A, with portions of the airbag folding structure removed to more clearly illustrate the formation of a laterally-extending lobe along each side of a pinch axis PX2 (i.e., lobes 350-1 and 350-2) of the airbag as a result of the pinching operation. Referring to FIG. 12, in a next step, a portion an edge 320a of the airbag 320 may be pinched in direction D7 along at least one portion of an edge intersecting the rapid deployment axis RD2, as previously described. In one or more arrangements, the pinch axis PX2 is coaxial with rapid deployment axis RD2. As previously described, the pinching may be used to ensure more rapid deployment of the pinched portion of the edge 320a of the in the direction RD2 to ensure cushioning of an occupant seated in seat 99.

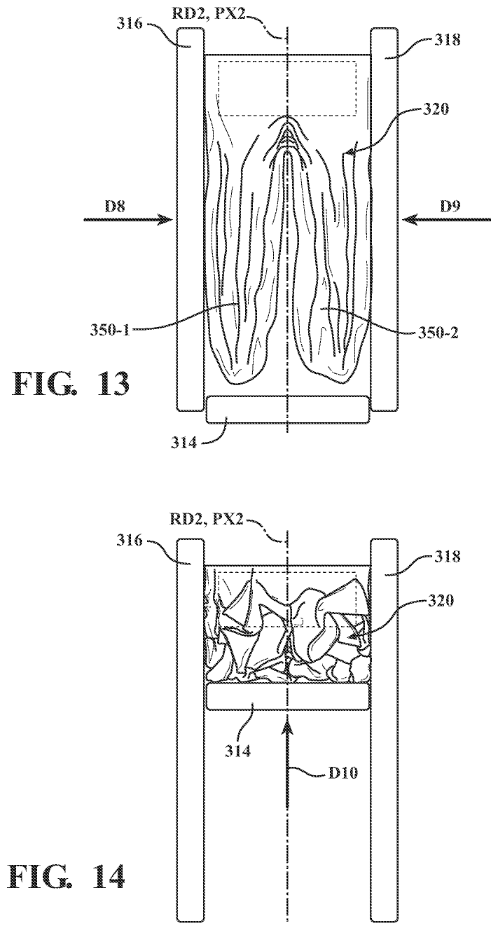

FIG. 13 is a schematic plan view of a next step similar to that shown in FIG. 3, illustrating performance of a lateral compression operation on the laterally-extending lobes 350-1 and 350-2 of the airbag of FIGS. 10B-12 by a pair of opposed lateral compression members 316 and 318 following the step shown in FIG. 12. Referring to FIG. 13, the airbag 320 may be laterally compressed in directions D8 and D9 using the lateral compression members 316 and 318, respectively. This operation may compress the lobes 350-1 and 350-2 toward the rapid deployment axis RD2.

FIG. 14 is a schematic plan view showing a final folding step including a longitudinal compression of the airbag of FIGS. 10B-13 following completion of the lateral compression operation shown in FIG. 13. Referring to FIG. 14, the laterally compressed airbag 20 may be longitudinally compressed in direction D10 by a longitudinal compression member 314 to provide an installation-ready airbag component. As previously described, the longitudinal compression member 314 may be sized to longitudinally compress the airbag 320 along an entire current width dimension of the airbag. Also as previously described, the lateral and longitudinal compression steps described above may reduce an overall length dimension and width dimension of the airbag 320 so that the airbag in its final folded form fits inside a space envelope of an associated airbag module housing (not shown) during installation.

Any of the airbag folding and pre-folding operations described herein (such as pinching a portion of an edge of the airbag, wrapping over a portion of the airbag so as to overlie another portion of the airbag, positioning a portion of the airbag over a projection in the working surface to elevate the portion of the airbag prior to folding, and other folding operations) may be performed on any of various different types of occupant airbags (i.e., driver airbags, side airbags, curtain airbags, knee airbags, etc.), to achieve the deployment effects described herein.

In the above detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope of the invention.

1. A method of folding an airbag to provide an installation-ready airbag component for an airbag module, the method comprising steps of:
positioning the airbag on a working surface;
pinching at least one portion of an edge of the airbag along a rapid deployment axis of the airbag;
laterally compressing the airbag to provide a laterally compressed airbag; and
longitudinally compressing the laterally compressed airbag.

2. The airbag of claim 16, wherein the rapid deployment axis is a 12 o'clock-6 o'clock axis.

3. The method of claim 1, further comprising a step of, prior to the step of laterally compressing the airbag, pinching another portion of the airbag residing opposite the at least one portion of the airbag and along the rapid deployment axis so as to form a pair of opposed laterally-extending lobes, and wherein the step of laterally compressing the airbag comprises laterally compressing the lobes.

4. The method of claim 3, further comprising a step of, prior to the steps of pinching, positioning a portion of the airbag on a projection extending from the working surface so as to elevate the portion of the airbag above a remainder of the airbag.

5. The method of claim 4, wherein the airbag is structured to have a circular shape in plan view when positioned in a flat state on a flat working surface prior to folding, and wherein the portion of the airbag to be positioned on the projection is at a geometric center of the circular shape.

6. An airbag module comprising an installation-ready airbag component fabricated in accordance with the method of claim 4.

7. The method of claim 1, further comprising a step of, prior to the step of laterally compressing the airbag, wrapping over a portion of an edge of the airbag so as to overlie another portion of the airbag.

8. The method of claim 7, further comprising a step of laying the airbag generally flat on a flat working surface prior to pinching or wrapping over the airbag.

9. The airbag of claim 20, wherein the portion of the edge of the airbag comprises a portion of the airbag edge wrapped over the other portion of the airbag along a fold line extending perpendicular to the rapid deployment axis.

10. The airbag of claim 9, wherein the at least one pinched edge portion of the airbag resides at a 6 o'clock position prior to pinching, and the portion of the airbag wrapped over the other portion of the airbag is located at a 12 o'clock position of the airbag prior to folding the airbag.

11. The method of claim 8, wherein the step of laying the airbag on a working surface comprises positioning a portion of the airbag on a projection extending from the working surface and structured so as to elevate the portion of the airbag above a remainder of the airbag both before and after folding of the remainder of the airbag is complete.

12. The method of claim 11, wherein the airbag is structured to have a circular shape in plan view when positioned in a flat state on the working surface, and wherein the portion of the airbag to be positioned on the projection is located at a geometric center of the circular shape.

13. An airbag module comprising an installation-ready occupant airbag in accordance with claim 9.

14. The sensor system of claim 10 wherein the cargo door is a tailgate of a pickup truck.

15. The airbag of claim 16, wherein the at least one pinched edge portion is pinched until it reaches a location where inflation gas is to enter the airbag or physically contacts a feature or object that prevents further pinching in a direction in which the at least one portion of the airbag is being pinched.

16. An occupant airbag for a vehicle, the airbag comprising:
at least one pinched edge portion residing along a rapid deployment axis of the airbag;
a first face structured to contact a working surface prior to airbag folding; and
a second face positioned opposite the first face and structured to contact a vehicle occupant after airbag deployment,
wherein a portion of an edge of the airbag is wrapped over so as to overlie the second face, so that a portion of the first face is structured to reside opposite the occupant prior to airbag deployment.

17. The airbag of claim 16, wherein the airbag is structured to have a circular shape in plan view when positioned in a flat, uninflated state on a flat working surface prior to folding, and wherein a pinch axis of the at least one pinched edge portion extends through a geometric center of the circular shape.

18. The airbag of claim 16, further comprising another pinched edge portion residing diametrically opposite the at least one pinched edge portion.

19. The airbag of claim 18 further comprising a pair of compressed laterally-extending lobes, one lobe of the pair of lobes being formed along on each side of opposite sides of the rapid deployment axis.

20. The airbag of claim 16, further comprising a portion of an edge of the airbag wrapped over so as to overlie another portion of the airbag.

21. The airbag of claim 16, wherein the airbag is folded so that during deployment of the airbag, the wrapped over portion fully deploys only after full deployment of any pinched portions of the airbag and also after full deployment of any remaining portions of the airbag.

22. The airbag of claim 16, wherein the airbag is folded so that when the airbag is deployed, a time required for the wrapped over portion of the airbag to fully deploy correlates inversely with a predetermined distance from a geometric center of the airbag to a fold line extending between the wrapped over portion and a remainder of the airbag, and also extending perpendicular to the rapid-deployment axis.

23. An occupant airbag for a vehicle, the airbag comprising:
a single pinched edge portion residing along a rapid deployment axis of the airbag;
a first face structured to contact a working surface prior to airbag folding; and
a second face positioned opposite the first face and structured to contact a vehicle occupant after airbag deployment,
wherein a portion of an edge of the airbag separate from the pinched edge portion is wrapped over so as to overlie the second face, so that a portion of the first face is structured to reside opposite the occupant prior to airbag deployment.
